(19) United States
(12) Patent Application Publication
(10) Pub. No.: US 2010/0320304 A1
(43) Pub. Date: Dec. 23, 2010

(54) REEL DEVICE FOR WINDING ELONGATED BODY

(76) Inventors: Kimitaka Iguchi, Osaka (JP); Hiroshi Yamano, Osaka (JP); Takuma Fukuda, Osaka (JP); Tadashi Hattori, Osaka (JP); Yoshinori Matsushita, Osaka (JP)

Correspondence Address: BIRCH STEWART KOLASCH & BIRCH, PO BOX 747, FALLS CHURCH, VA, 22040-0747, US

(21) Appl. No.: 12/918,434

(22) PCT Filed: Dec. 26, 2008
(86) PCT No.: PCT/JP2008/073706

§ 371 Date: Aug. 19, 2010

(30) Foreign Application Priority Data
May 30, 2008 (JP) 2008-143371

(51) Int. Cl. B65H 75/44; H02G 11/02; B65H 75/38

(52) U.S. Cl. 242/388.91; 242/397

(57) ABSTRACT

A reel for winding an elongated body includes a rotor 30 that pivots relative to a casing, a free roller 22 located on the outer peripheral side of the rotor 30, and an inner reel section 30 formed on the inner side thereof. An elongated body is wound in one direction on the outer periphery of the inner reel section 23, and the elongated body extending from the inner reel section is reversed by a reversing roller 21, wound in the other direction on the outer periphery of the free roller 22, and pulled out to the outer periphery of the rotor. The inner reel section 23 is adapted to be pivotable relative to the rotor 30. The pivot shaft of the inner reel section 23 is placed at a position different from the position of the center axis 11 for pivoting of the rotor 30. The reel has a pivoting device for pivoting the inner reel section 23 such that the rotor 30 and the inner reel section 23 pivot in the directions opposite to each other with substantially the same angular speed.

### TECHNICAL FIELD

The present invention relates to a reel device for winding an elongated body. Here, the elongated body includes a hose that runs a fluid such as water and air, a thread, a string, a metal wire, etc., besides a power cord and a communications cable.

### BACKGROUND ART

Conventionally, cord reels have been widely used for winding electrical or communications cords and cables. The cord reels are divided roughly into a contact type and a non-contact type; the contact type separates a cord on a rotating side that is connected to a winding rotor side to rotate from a cord provided on a fixing side such as a casing, and performs only an electrical connection by a contact, and the non-contact type uses substantially a series of cords without separating both cords described above.

As shown in Patent Literatures 1 and 2, there has been proposed a non-contact cord reel including two reel sections of an outer reel section and an inner reel section. This reel includes a rotor that pivots about a center axis, an outer reel section provided at an outer peripheral side of the rotor, and an inner reeling roller formed coaxially with the center axis of the rotor, and configured such that an elongated body is wound in one direction on the outer periphery of the inner reel section, and the elongated body extending from the inner reel section, as a result of passing through a reversing roller, is wound in the other direction on the outer periphery of the outer reel section and pulled out to the outer periphery of the rotor. The inner reeling roller and reversing roller that are set with their radii large eliminate the necessity for excessively distorting the cord and exert less of a load on the cord, resulting in a smooth operation. However, when the inner reeling roller is placed in the center of the rotor, there is provided a structure where the reversing roller fitted to the rotor rotates on its outer periphery, and thus, a part to be occupied by these results in a circle having a radius larger than a sum of the radius of the inner reeling roller and the diameter of the reversing roller. That is, even when the device is downsized, this circle of area is at least required.

Patent Literature 1: JP patent application laid-open No. H11-116145

Patent Literature 2: JP patent application laid-open No. 2004-328985

### DISCLOSURE OF THE INVENTION

It is an object of the present invention to downsize a reel, which is a reel for winding an elongated body including a rotor that pivots about a center axis, an outer reel section provided at an outer peripheral side of this rotor, and an inner reel section formed at an inner peripheral side of this rotor and inside of the outer reel section, in which an elongated body is wound in one direction on the outer periphery of the inner reel section, and the elongated body extending from the inner reel section is wound on the outer periphery of the outer reel section and pulled out to the outer periphery of the rotor.

In a first aspect of the present invention according to claim 1, provided is a reel for winding an elongated body including a rotor that pivots relative to a base, an outer reel section provided at an outer peripheral side of the rotor, an inner reel section formed at an inner peripheral side of the rotor and inside of the outer reel section, and a guide section, in which an elongated body is wound in one direction on the outer periphery of the inner reel section, and the guide section guides the elongated body extending from the inner reel section to the outer reel section, in which the inner reel section is fixed to the base, the rotor is provided to be pivotable relative to the inner reel section, and the guide section orbits around the inner reel section with the pivoting of the rotor, and the guide section is disposed at a position different from that of the inner reel section in terms of a direction along the axis of the rotor.

In a second aspect of the present invention according to claim 2, provided is the reel for winding an elongated body according to claim 1 in which the guide section is a reversing roller that reverses the elongated body extending from the inner reel section to be wound on the outer periphery of the outer reel section and pulled out to the outer periphery of the rotor, a center axis of the inner reel section is disposed so as to be coincident with a center axis of pivoting of the rotor, and with projection onto a plane perpendicular to the axis of the rotor, at least a part of the inner reel section overlaps with the guide section.

In a third aspect of the present invention according to claim 3, provided is the reel for winding an elongated body according to claim 1 in which the guide section includes a forward-rotating section and a reversing section, in which the forward-rotating section is for guiding without reversing the elongated body extending from the reel section to the reversing section, and the reversing section is for reversing the elongated body extending from the forward-rotating section to be wound on the outer periphery of the outer reel section and pulled out to the outer periphery of the rotor; and a part of the elongated body between the forward-rotating section and the reversing section three-dimensionally intersects with a part of the elongated body wound around the inner reel section at different positions in terms of the direction along the axis of the rotor.

In a fourth aspect of the present invention according to claim 4, provided is a reel for winding an elongated body including a rotor that pivots relative to a base, an outer reel section provided at an outer peripheral side of the rotor, and an inner reel section formed at an inner peripheral side of the rotor and inside of the outer reel section, in which an elongated body is wound in one direction on the outer periphery of the inner reel section, and the elongated body extending from the inner reel section in the other direction on the outer periphery of the outer reel section is pulled out to the outer periphery of the rotor, in which the inner reel section is provided to be pivotable relative to the rotor, and a pivot shaft of the inner reel section is disposed at a position different from that of a center axis of pivoting of the rotor, and the reel for winding an elongated body includes an inner reel section pivoting device that pivots the inner reel section relative to the rotor.

In a fifth aspect of the present invention according to claim 5, provided is the reel for winding an elongated body according to claim 4, in which the elongated body extending from the inner reel section is reversed to be wound around the outer reel section, and pulled out to the outer periphery of the rotor, and the inner reel section pivoting device pivots the inner reel section in an opposite direction to a direction of pivoting of the rotor.

In a sixth aspect of the present invention according to claim 6, provided is the reel for winding an elongated body according to claim 4 or 5, in which a reversing roller that reverses the elongated body is provided between the outer reel section and the inner reel section to be pivotable relative to the rotor, and the outer reel section has a radius smaller than a sum of a diameter of the reversing roller and a radius of the inner reel section.

In a seventh aspect of the present invention according to claim 7, provided is the reel for winding an elongated body according to any one of claims 4 to 6, in which for the outer reel section, a plurality of free rollers and a reversing roller are arranged spaced apart from each other in an annular shape, and an elongated body wound around the inner reel section is reversed at the outer periphery of the reversing roller, and the elongated body, which is a power or communications cord including a metal wire inside, includes a spiral spring that urges the rotor in one rotating direction, and rotates the rotor by an elasticity of the spiral spring to thereby wind the cord.

An eighth aspect of the present invention according to claim 8 provides the reel for winding an elongated body according to any one of claims 4 to 7, in which a plurality of turns of a cord is wound around the inner reel section so as to be layered in a radial direction of the inner reel section, and a plurality of turns of the cord is wound around the outer reel section so as to be layered in an axial direction of the outer reel section.

A ninth aspect of the present invention according to claim 9 provides the reel for winding an elongated body according to claim 4, a reversing section that reverses the elongated body extending from the inner reel section to be wound on the outer periphery of the outer reel section and pulled out to the outer periphery of the rotor is included, and a part of the elongated body between the reversing section and the inner reel section three-dimensionally intersects with a part of the elongated body wound around the inner reel section at different positions in terms of a direction along the axis of the rotor.

In the first to the third aspects of the present invention, the present invention includes a rotor that pivots about a center axis, an outer reel section provided at an outer peripheral side of the rotor, and an inner reel section formed at an inner peripheral side of the rotor and inside of the outer reel section, for winding an elongated body in one direction on the outer periphery of the inner reel section, a guide section orbiting around the inner reel section with the pivoting of the rotor, in which as a result of the guide section being disposed at a position different from that of the inner reel section in terms of a direction along the axis of the rotor, the degree of freedom of design of the reel is increased in terms of an inner and outer direction of the rotor diameter, and for example, as in the second aspect, by overlapping the guide section with the inner reel section in a plan view, that is, in a state of projection onto an imaginary plane perpendicular to the axis of the rotor, the reel can be further downsized.

Moreover, in the fourth to the ninth aspects of the present invention, the present invention includes a rotor that pivots about a center axis, an outer reel section provided at an outer peripheral side of the rotor, and an inner reel section formed at an inner peripheral side of the rotor and inside of the outer reel section, for winding an elongated body in one direction on the outer periphery of the inner reel section, and reversing and winding the elongated body extending from the inner reel section in the other direction on the outer periphery of the outer reel section and pulling out the elongated body to the outer periphery of the rotor, in which since it becomes no longer necessary to arrange a center of the inner reel section on the center axis of rotation of the rotor, a reel device for winding an elongated body where the degree of freedom of design is increased and downsizing of the device is also enabled can be provided.

### BRIEF DESCRIPTION OF THE DRAWINGS

FIG. 1(A) is a plan view of a reel device according to a first embodiment, and FIG. 1(B) is a plan view of a reel device according to a second embodiment.

FIG. 2 is a structural explanatory view of the same observed laterally.

FIG. 3 is a structural explanatory view of the same observed laterally, wherein FIG. 3(A) shows a state of a first turn, and FIG. 3(B) shows a state of a fifth turn.

FIG. 4 is a plan view of a casing bottom portion.

FIG. 5 is an explanatory view of a reel device according to the third embodiment, observed laterally.

FIG. 6 shows a movement guide, wherein FIG. 6(A) is a perspective view showing a usage state, FIG. 6(B) is a perspective view, and FIG. 6(C) is a front view.

FIG. 7 explains the mechanism for avoiding a twist in a cord in the first to third embodiments, wherein FIG. 7(A) to FIG. 7(C) are plan views, with the main parts omitted, showing twist preventing manners in the first to third embodiments, respectively, and FIG. 7(D) and FIG. 7(E) are plan views, with the main parts omitted, of comparative examples applied with no twist prevention.

FIG. 8 shows another embodiment of a movement guide, wherein FIG. 8(A) is a perspective view, and FIG. 8(B) is a front view.

FIG. 9 is an explanatory view of a reel device according to a fourth embodiment observed laterally.

FIG. 10 is a plan view of a reel device according to a fifth embodiment.

FIG. 11 is a sectional view along w-w of FIG. 10 of a reel device according to a sixth embodiment.

### BEST MODES FOR CARRYING OUT THE INVENTION

Hereinafter, embodiments of the present invention will be described based on the drawings.

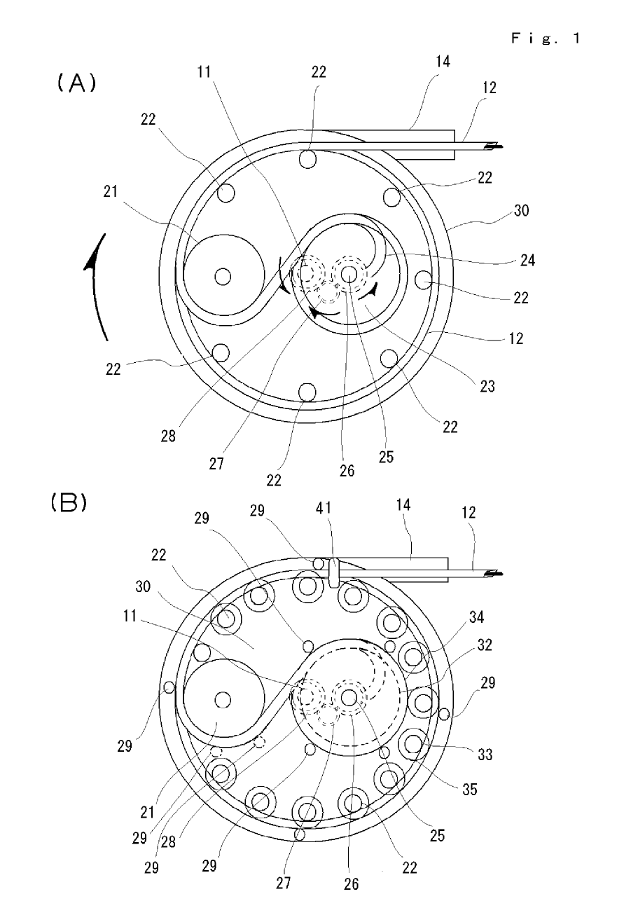

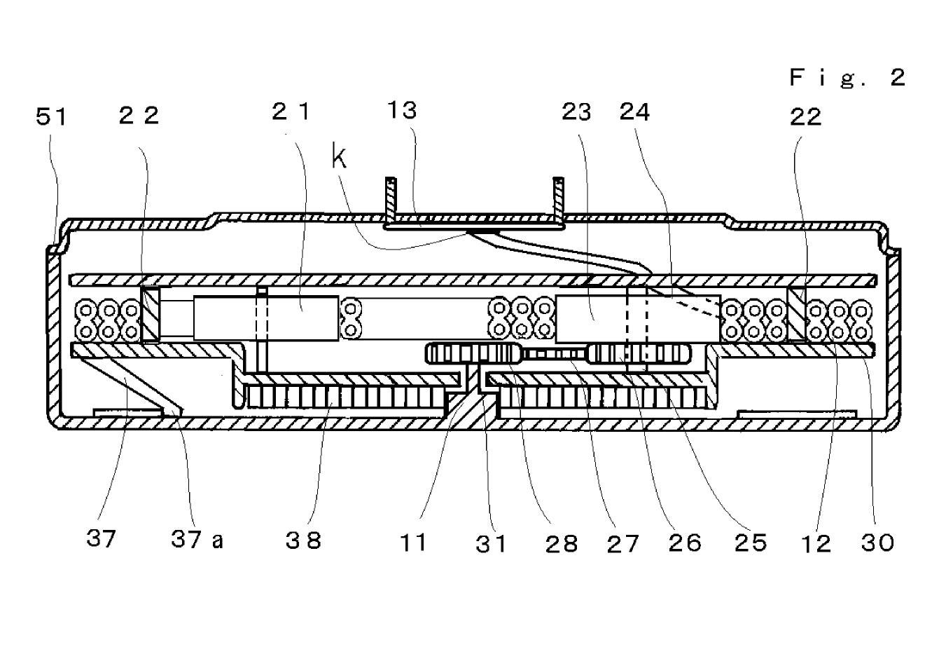

FIG. 1(A) is a plan view of a reel device according to a first embodiment, and FIG. 2 is a structural explanatory view of the same observed laterally. The embodiment shown in FIG. 1(A) and FIG. 2 corresponds to claims 4 to 7.

A cord reel according to this embodiment includes a disk-shaped rotor 30 that pivots about a support shaft 11, a reversing roller 21 and a free roller 22 provided at the outer peripheral side of an upper surface of this rotor 30, and an inner reel section 23 formed at the inner peripheral side of this rotor 30. The rotor 30, which is arranged to be pivotable relative to a casing 51 serving as a base, has in this example an insertion hole 31 to be fitted by insertion over the support shaft 11 in a center portion as shown in FIG. 2, and as a result of this insertion hole 31 being fitted by insertion over the support shaft 11 of the casing 51, the rotor 30 is pivotally stored in the casing 51.

The free roller 22 is a component of an outer reel section. The free roller 22 and the above-mentioned reversing roller 21 are arranged substantially in an annular shape (more desirably, so that the reversing roller 21 and the free roller 22 are arranged at the vertices of a regular polygon), and a cord 12 is wound on the outer peripheral surface thereof. The reversing roller 21 and the free roller 22 are each provided so as to be freely rotatable by a shaft provided on the upper surface of the rotor 30. The reversing roller 21 and the free roller 22 may not always be rotatable, and may be provided as annular wall surfaces.

With regard to the quantity of reversing roller 21 and free roller 22, it suffices to provide one or more reversing roller 21 and two or more free rollers 22 so that these rollers form the vertices of a polygon. The intervals to provide the reversing and free rollers 21 and 22 are desirably equalized, but do not always have to be set equal.

The size relationship between the radius of the reversing roller 21 and the radius of the free roller 22 can be freely set, and can be either that the radius of the reversing roller 21 is set to be the same or greater than the radius of the free roller 22 or the radius of the free roller 22 is set to be greater than the radius of the reversing roller 21.

The inner reel section 23 exhibits a circular shape in a plan view, has a pivot shaft 25 in the center of its circle, and is provided so as to be rotatable relative to the rotor 30 by this pivot shaft 25. The pivot shaft 25 is provided at a position different from the support shaft 11 of the rotor 30. The inner reel section 23 is provided with an inner reel section wheel 26 so as to rotate as one, and this inner reel section wheel 26 meshes with a rotor wheel 28 via an intermediate wheel 27. The inner reel section wheel 26 is provided to be pivotable on the upper surface of the rotor 30. The rotor wheel 28 is provided integrally with the support shaft 11 (eventually, the casing 51), and is in a stationary state in contrast to the pivoting rotor 30. The inner reel section wheel 26 and the rotor wheel 28 are set to be the same in the number of wheels and thus rotate at the same rotational speed, and are connected via a single intermediate wheel 27 and thus have a relationship to pivot in the same direction.

That is, the inner reel section wheel 26, the intermediate wheel 27, and the rotor wheel 28 are to serve as an inner reel section pivoting device set forth in the claims, and the rotor wheel 28, a center axis of which is coincident with a center axis of the rotor 30, is thus integrated with the casing 51 (base), and the inner reel section wheel 26, a center axis of which is coincident with a center axis of the inner reel section 23, is thus integrated with the inner reel section 23, and the intermediate wheel 27 is provided between both wheels 28 and 26 to transmit a rotational force. As a result, when the rotor 30 rotates counterclockwise, the rotor wheel 28 provided integrally with the casing 51 does not rotate (rotates clockwise relative to the rotor 30). The intermediate wheel 27 meshes with the rotor wheel 28 while rotating counterclockwise. The inner reel section wheel 26 meshes with the intermediate wheel 27 while rotating clockwise, and the inner reel section 23 being one with the inner reel section wheel 26 also rotates clockwise.

Here, a relative rotational speed of the inner reel section wheel 26 (eventually, the inner reel section 23) relative to the rotor 30 is determined by a gear ratio between the rotor wheel 28 and the inner reel section wheel 26. In this example, as a result of both wheels being set to be substantially equal in gear ratio, the rotor 30 and the inner reel section 23 rotate in the directions opposite to each other with substantially the same angular speed.

As the inner reel section pivoting device, besides a gear, a transmission structure by a chain, a transmission structure by a timing belt, and the like can be provided by appropriate modification as long as it is means that makes the inner reel section 23 reverse relative to the rotor 30 in mechanical or electrical synchronization. Particularly, as a result of providing the rotor 30 and the inner reel section 23 so as to rotate in the directions opposite to each other with substantially the same angular speed, even when the rotor 30 rotates about the support shaft 11, the inner reel section 23, without rotating on its own axis, only rotationally moves around the support shaft 11 in accordance with a rotation of the rotor 30. Consequently, the possibility of a twist that may be produced in the cord 12 can be eliminated. It suffices to provide this inner reel section pivoting device on the upper surface side of the rotor 30, but it may also be possible, in order to prevent contact with the cord 12 and other parts, to form a recess portion in the rotor 30 and arrange the inner reel section pivoting device within this recess portion, or to provide the rotor 30 as a double structure, and store the inner reel section pivoting device inside of the double structure.

As in above, the inner reel section 23 is desirably rotated in the direction opposite to the rotating direction of the rotor 30 with substantially the same angular speed, but it is not always necessary to rotate the inner reel section 23 with the same angular speed as long as this allows reducing a twist in the cord 12, and it is not detrimental to use. Particularly, depending on the degree of slipping of the cord and the like, the reel amount can be slightly different between the inner and outer reel sections, and in such a case, it is desirable not to make both sections completely the same in rotational speed but slightly adjust the rotational speed.

Thus, preventing a twist in a cord is particularly important in carrying out the invention as a non-contact cord reel with a continuous series of cords without cutting the cord, but is not to inhibit carrying out the invention as a cord reel with a contact. In that case, it suffices to divide the cord 12, near where the cord 12 is led out of the casing 51 into parts inside and outside of the casing, and electrically connect the divided cords 12 to each other by a contact that can maintain connection even with a rotation.

In this inner reel section 23, a fixing portion 24 where the cord 12 is fixed is formed. This fixing portion 24 is for fixing a portion close to the base end of the cord 12 to the inner reel section 23, and the cord 12 is led into the inner reel section 23 from an outer peripheral part thereof and fixed.

However, as long as the cord reel functions as a reel, the portion close to the base end of the cord 12 mentioned above is not necessarily fixed.

As shown in FIG. 2, the side closer to the base end of the cord 12 is led out upward from a central portion of the inner reel section 23 and connected to a power supply connecting section 13 provided on the casing 51. This power supply connecting section 13 can be provided as a terminal in various modes, and may be a terminal that can be connected with an attachment plug, or may be a terminal where fixation by soldering, screwing, or the like is available.

The foregoing prevention of a twist in a cord means reducing a twist in a cord between the above-mentioned fixing portion 24 and a portion k of the power supply connecting section 13 to which the cord 12 is fitted. The twist is reduced by rotating the inner reel section relative to the rotor by means of the foregoing inner reel section rotating device.

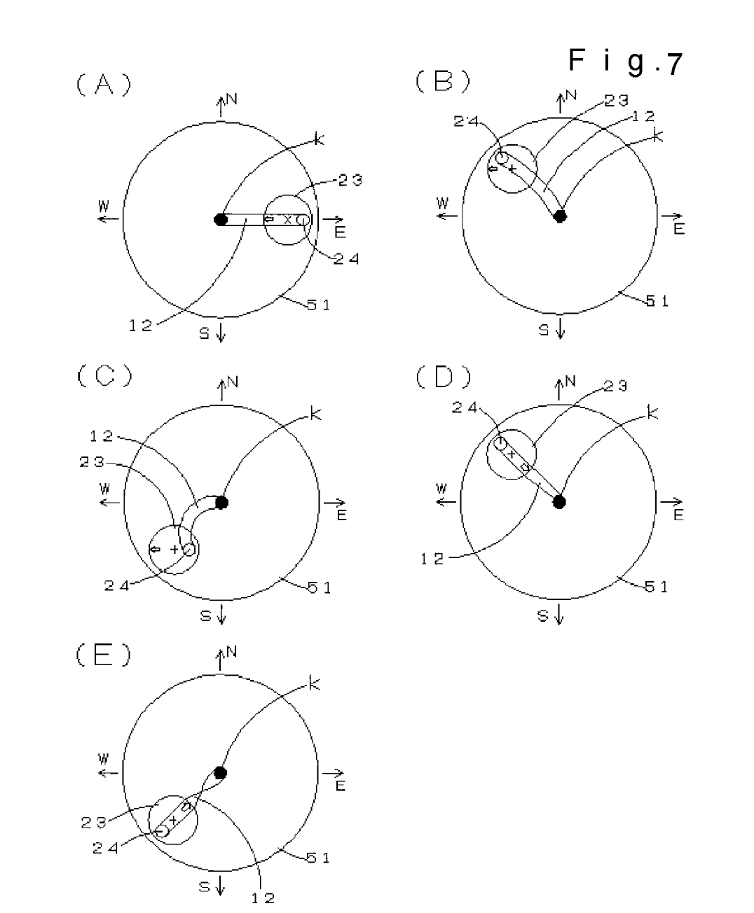

Here, the reduction in a twist will be described, by using FIG. 7, in terms of more preferred examples. In FIG. 7(A) to FIG. 7(E), for convenience of description, the outline arrow indicates the front of the inner reel section 23, and the cross (x) indicates a pivot shaft of the inner reel section 23. Moreover, for convenience of description, the E, W, S, and N indicate east, west, south, and north, respectively.

As shown in FIG. 7(A) to FIG. 7(C), the inner reel section is turned relative to the rotor so as not to rotate the inner reel section on its own axis, and the orientation of the inner reel section 23, that is, the front of the inner reel section 23 does not change in its orientation of north, south, east, and west even when the inner reel section 23 turns (revolves) in accordance with a rotation of the rotor 30. Therefore, between the fixing portion 24 and the fitting portion k, even when the inner reel section 23 turns in accordance with a rotation of the rotor 30, no twist is produced in the cord 12.

Suppose that the inner reel section 23 rotates on its own axis, for example, rotates on its own axis like the moon always shows the same surface to the earth, as shown in FIG. 7(D) to FIG. 7(E), that is, in the case of going around from the state of FIG. 7(A) into as shown in FIG. 7(D), and then FIG. 7(E), a twist is produced in the cord 12.

As described above, by not rotating the inner reel section 23 on its own axis, such a twist in the cord 12 can be reliably prevented, as described above. However, even with some rotation on its own axis involved, by turning the inner reel section relative to the rotor, as compared to the inner reel section that is not turned relatively, a twist can be reduced, and such an implementation of the invention is not excluded.

In addition, as shown in FIG. 7(A) to FIG. 7(C), the fixing portion 24 cannot be provided in the center of the inner reel section because of the presence of the pivot shaft of the inner reel section 23, and is located at a position off the center of the inner reel section. Accordingly, when the inner reel section 23 turns, the interval between the fixing portion 24 and the fitting portion k of the cord 24 changes with a turn of the inner reel section 23. As shown in FIG. 7(A), in a plan view (in a state of projection onto a plane perpendicular to an axial direction of the rotor), when the fixing portion 24 is located, across the pivot shaft of the inner reel section 23, at the side opposite to the fitting portion k, the distance between the fixing portion 24 and the fitting portion k is the greatest. For the cord 12, the length between the fixing portion 24 and the fitting portion k is determined with reference to the case with this greatest distance. Therefore, the inner reel section 23 turns (revolves), and as shown in FIG. 7(B) and FIG. 7(C), the distance between the fixing portion 24 and the fitting portion k is reduced from the state shown in FIG. 7(A), so that the cord 12 is slackened. However, as shown in FIG. 7(B) and Fig. (B), the cord 12 may be slackened or tensed, but is never twisted, as mentioned above. On the other hand, in the case shown in FIG. 7(D) and FIG. 7(E), since the length between the fixing portion 24 and the fitting portion k is fixed, the cord 12 is never slackened or tensed, but as described above, a twist is produced by a rotation on its own axis.

The cord 12 led out of the fixing portion 24 is wound around the reversing roller 21 to be reversed, wound on the outer periphery of the free rollers 22 as in the foregoing, and drawn to the outside from a draw-out opening 14 provided in the casing 51.

In the case shown in FIG. 1(A), when the cord 12 is tracked from the base end side (fixing portion side) of the cord 12 to the front end side, the reeling direction of the cord 12 on the inner reel section 23 is counterclockwise, and the reeling direction is reversed by the reversing roller 21, and the reeling direction of the cord on the outer reel section is clockwise.

In addition, although not shown, this cord 12 has a front end portion of the same configuration as that of the conventional cord reel, such that an attachment plug or the like is connected to the front end of the cord 12.

In the embodiment shown in FIG. 1(A) and FIG. 2 mentioned above, the inner reel section 23 and the reversing roller may be arranged at different positions in terms of a direction along the axis of the rotor 30.

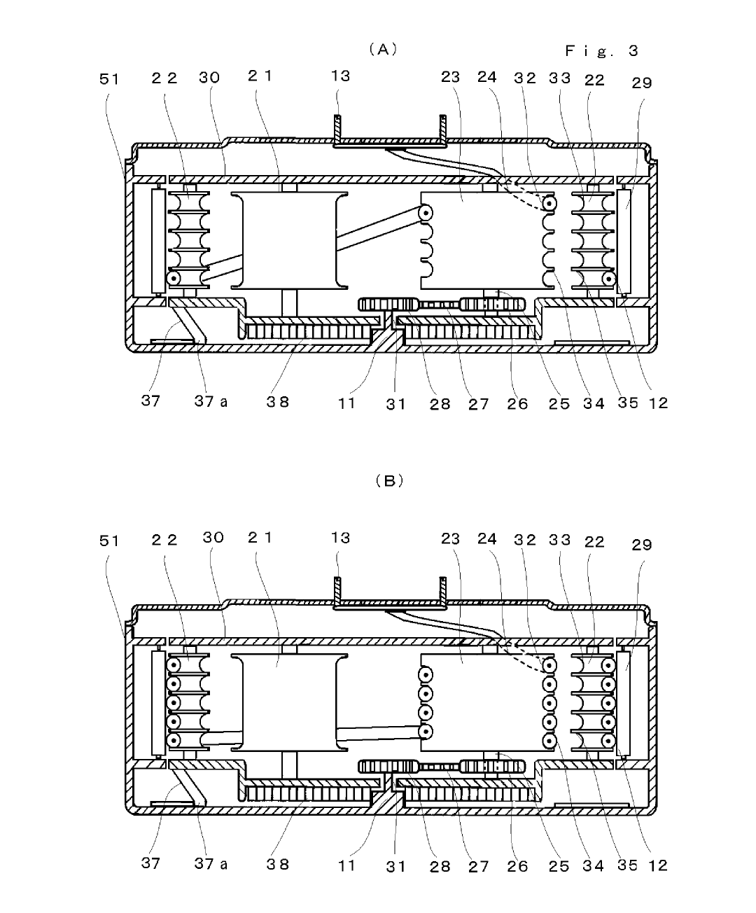

Here, when the rotor 30 rotates one time about the support shaft 11, the inner reel section 23 also turns one time around the support shaft 11, so that the cord 12 is wound one time each on the outer periphery of the inner reel section 23 and the outer periphery of the outer reel section (reversing roller 21 and free rollers 22). Further, the number of times of winding around both reel sections respectively increases according to the number of times of rotation of the rotor 30. In that case, as for the number of winding onto both reel sections, a plurality of turns of cord 12 is layered in the radial direction (FIG. 2), but in consideration of smooth reeling and unreeling of the cord 12, it is also possible, as shown in FIG. 1(B) and FIG. 3, to layer a plurality of turns of cord 12 in the axial direction.

As shown in FIG. 3, when a plurality of turns of cord 12 is layered in the axial direction, the inner reel section 23 and the outer reel section (reversing roller 21 and free rollers 22) are each formed long in the axial direction so as to allow disposing a plurality of cords 12 in the axial direction. Desirably, in each of the inner reel section 23 and the free rollers 22, a recess portion 32, 33 for guiding the cord 12 is formed. The recess portion 32 of the inner reel section 23 is provided so as to run on its outer peripheral surface in a helical shape. Moreover, the recess portions 24 of the free rollers 22 are gradually changed in height so as to run in a helical shape in the free roller 22 group as a whole. Further desirably, a projection portion 34, 35 between the recess portions 32, 33 and the recess portion 32, 33 is provided sufficiently protruded in the radial direction, so that the cords 12 to be layered in the axial direction do not contact each other, so as to prevent the partial surfaces of the cord 12 from being deteriorated by friction. However, without such restrictions, reeling may be performed at the discretion of the cord 12.

With regard to the first round of turns, reeling is performed on the inner reel section 23 from an upper side thereof close to the fixing portion 24 to make turns so as to be layered downward as the turn is repeated, while with regard to the free roller 22, winding is performed from a lower side thereof to make turns so as to be layered upward as the turn is repeated. However, the invention can also be carried out conversely, by layering a cord on the inner reel section 23 from a lower side to an upper side thereof, and on the free roller 22, from an upper side to a lower side thereof.

The reversing roller 21 serves to connect between the inner reel section 23 and the free roller 22, and the cord 12 to be wound therearound changes in its vertical position. Therefore, if there is unevenness formed on the reversing roller 21, a change in the vertical position of the cord 12 is thereby hindered, and it is thus desirable to keep its outer periphery flat and smooth.

Moreover, it suffices to arrange interval control rollers 29 in a manner surrounding the inner reel section 23 from outside, in order to arrange only one cord in the radial direction of the inner reel section 23 and the outer reel section (reversing roller 21 and free rollers 22). The interval control rollers 29 are desirably supported on the casing 51 side as shown in FIG. 3. Alternatively, although not shown, a non-rotating structure such as a wall surface of the casing 51 may be adopted in place of the rollers 29.

The interval control rollers 29, as shown by solid lines in FIG. 1(B), may be provided only outside of the inner reel section 23, but as shown by alternate long and short dashed lines in FIG. 1(B), the interval control rollers 29 are preferably provided, also outside of the reversing roller 21, in a manner surrounding the reversing roller 21.

Moreover, there may be a movement guide 41 provided at a lead-in part to the outer reel section from the draw-out opening 14 (see FIG. 1(B)) so that the cord 12 changes in the axial height while being smoothly led. This movement guide 41, which can be exemplified by one structured so as to move axially in accordance with a rotation of the rotor 30 by a gear or link, is for guiding the cord 12 so that a plurality of turns of cord 12 is layered more reliably in the axial direction.

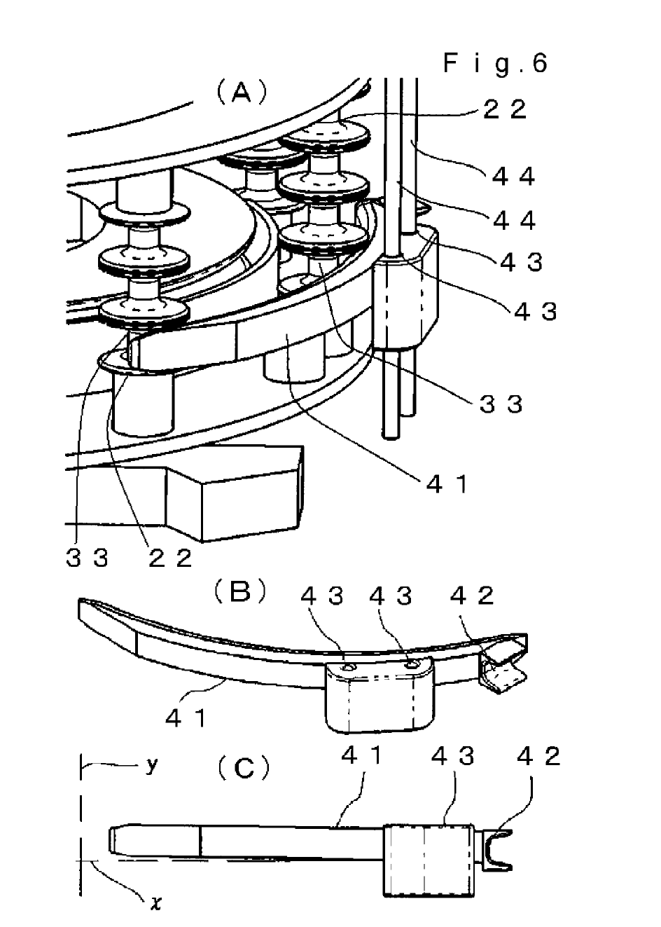

FIG. 6 shows an example of the movement guide 41, at one end of which a feed portion 42 of the cord 12 is provided substantially in a semicircular shape, and which makes this feed portion 42 guide the cord 12 to lead the cord 12 into the lead-in part to the outer reel section from the draw-out opening 14. This movement guide 41 exhibits an arcuate shape with a radius substantially equal to that of a circle formed by the free roller 22 group in a plan view, an inner surface side of which is engaged with the recess portions 33 of a plurality of free rollers 22 to be guided, and is formed, in a front view, to have an angle equal to a helical lead angle of the cord formed by the free roller 22 group as a whole (in FIG. 6(C), y indicates the direction of a center axis of the free roller 22, x indicates an imaginary plane perpendicular to y, and the movement guide 41 intersects with the imaginary plane x with the lead angle). Further, this movement guide 41 includes an axial to-be-fed portion 43 at an outer peripheral side thereof. This to-be-fed portion 43 is configured so as to be guided by a support 44 provided in the casing 51, and move vertically. Accordingly, when the rotor 30 including the free rollers 22 rotates about the support shaft 11, an inner peripheral surface of the movement guide 41 is fed sequentially by the recess portions 33 of the free rollers 22 to be moved vertically by the support 44. Consequently, the cord 12 is guided so as to move axially in accordance with a rotation of the rotor 30, and can be wound in a regular spiral.

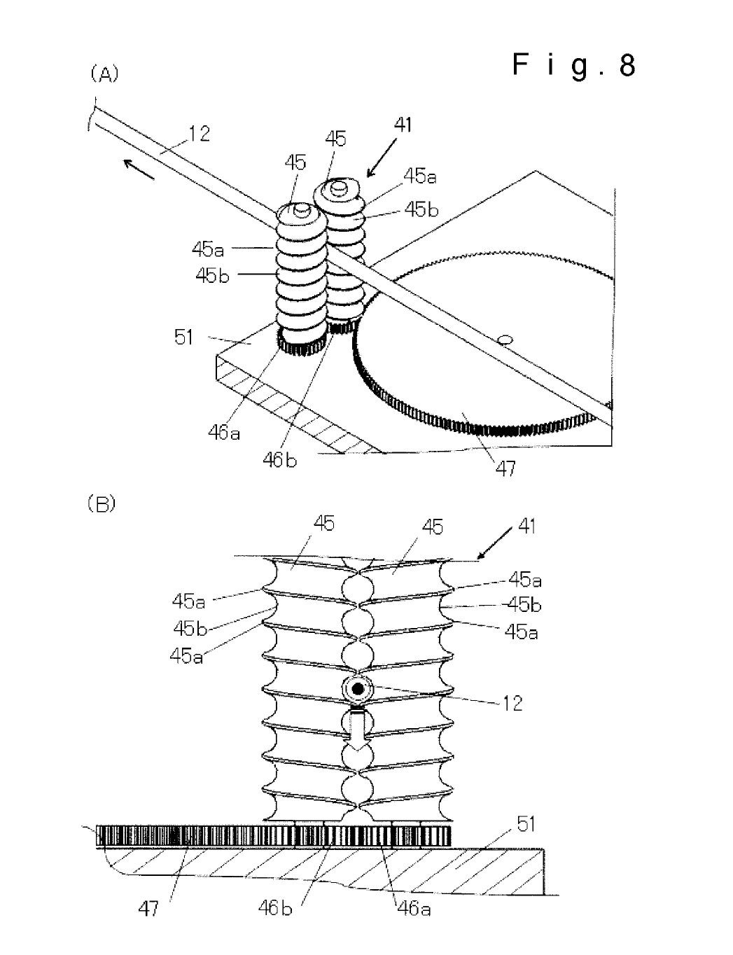

FIG. 8 shows another example of the movement guide 41 mentioned above.

As illustrated, the movement guide 41 includes two spiral shafts 45, 45 that guide the cord in the vicinity of the draw-out opening 14, pinions 46a, 46b provided at one end of each of the spiral shafts 45, 45 integrally with the spiral shafts 45, and a gear wheel 47 that is provided integrally with the rotor and rotates integrally with the rotor. One 46b of the pinions meshes with the gear wheel 47 and the other pinion 46a, and turns in response to a turn of the gearwheel 47 to turn the other pinion 46a in a direction opposite to that of its own.

Both spiral shafts 45, 45 include projection portions 45a formed in helices, respectively. Of the helical projection portion 45a, a part between apex portions neighboring in the axial direction forms a recess portion 45b that receives the cord 12.

As a result of the spiral shaft 45 rotating about its axis, the recess portion 45b is fed in one direction along the axis.

The helical projection portions 45a of both spiral shafts 45, 45 are equal in pitch, and also equal in rotation diameter, but are opposite in the direction of spiral.

Both spiral shafts 45, 45 are fitted, in the vicinity of the draw-out opening 14 of the cord, to the casing 51 so as to be parallel with a rotation shaft of the rotor. Both spiral shafts 45, 45 are provided in an adjacent manner in the casing 51, and as shown in FIG. 8(B), the apex portion of the projection portion 45a of one spiral shaft 45 corresponds with the apex portion of the projection portion 45a of the other spiral shaft 45, and the recess portions 45b, 45b of both spiral shafts 45, 45 correspond with each other.

As mentioned above, both spiral shafts 45, 45 are opposite to each other in the direction of spiral winding, and thus are in mirror symmetry in a side view, as shown in FIG. 8(B). Both spiral shafts 45, 45 rotate in mutually opposite directions based on a rotation of the gear wheel 47. However, as mentioned above, the directions of spiral are opposite, the feeding direction of the recess portions 46b due to this turn is the same in terms of either spiral shaft 45, 45.

As shown in FIG. 8(B), the cord 12 is, in the vicinity of the draw-out opening 14, located between both spiral shafts 45, 45, sandwiched with the recess portions 45b, 45b of both spiral shafts 45, 45, and restricted from movement in the direction along the axis of the spiral shaft by the projection portions 45a, 45a of both spiral shafts 45, 45.

When the gear wheel 47 rotates with a rotation in a cord reeling direction of the rotor, one pinion 46b and the other pinion 46a turn in opposite directions as mentioned above, both spiral shafts 45, 45, although turning in mutually opposite directions, feed the respective recess portions 46b, 46b in the same direction in terms of the axial direction of the spiral while drawing the cord 12 into the reel, and guide the cord 12 in one direction indicated by an outline arrow in FIG. 8(B).

Also, in the above, one pinion 46b is made to mesh with the gear wheel 47 and the other pinion 46a, but alternatively, the invention can also be carried out by not making both pinions 46a, 46b directly mesh with each other, but making one of the pinions directly mesh with the gear wheel, and separately providing a transmission gear between the other pinion and gear wheel so as to turn the other pinion in a direction opposite to that of one pinion.

With regard to both spiral shafts 45, 45, it is not limited to carry out the invention with the same direction of spiral of both spiral shafts 45, 45, as mentioned above, without forming these in mirror symmetry with opposite directions of spiral. Moreover, the invention can also be carried out by providing only one spiral shaft 45 and providing another spiral shaft across the cord 12 therefrom as a wall surface, or alternatively, as a rod-like body arranged parallel to the spiral shaft 45 (not shown). In this case, feeding out is performed by a rotation of a single spiral shaft 45, and during which the wall surface or rod-like body functions as a stopper so as to prevent the cord 12 from dropping out of the recess portions 45b of the spiral shaft 45.

Also, in FIG. 8(A), the casing 51 is shown with its bottom portion clipped in a rectangular shape, which is different from its actual shape, in order to avoid complexity of the drawing.

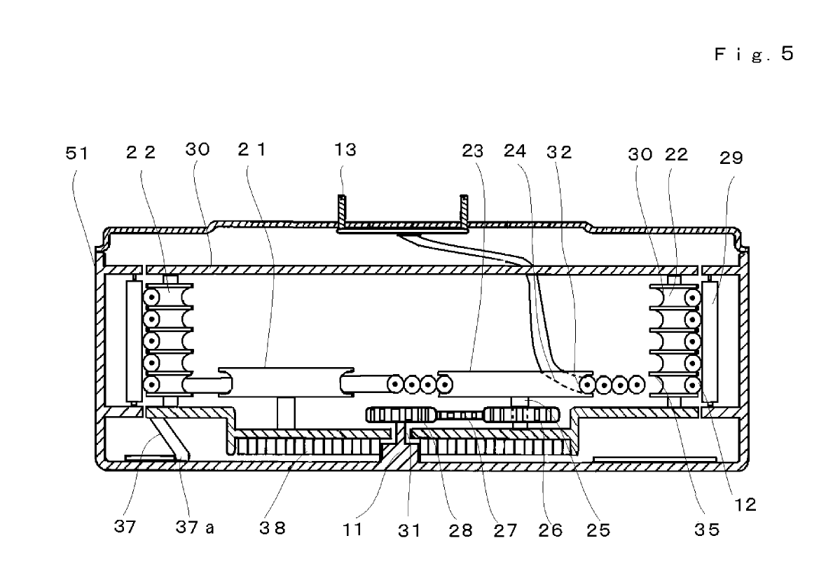

Next, an embodiment corresponding to claims 4 to 7 is shown in FIG. 5. In this example, the inner reel section 23 is wound with a cord layered in the radial direction, and the outer reel section (reversing roller 21 and free rollers 22) is circled with a cord layered in the axial direction. Alternatively, although not illustrated, the inner reel section 23 may be wound with a cord layered in the axial direction, and the outer reel section, circled with a cord layered in the radial direction, conversely. Also, in the present invention, the cord 12 can have any length, and may be a cord to be wound around the inner reel section 23 and the outer reel section (reversing roller 21 and free rollers 22) one or more and a plurality of turns each, but may be conversely a short cord that is wound around these only about a half turn.

As in the above, one of the merits of not providing the inner reel section 23 coaxially with the rotor 30, downsizing of the device can be mentioned, and downsizing features appear when the radius of the outer reel section (accurately, the distance from the center of the rotor 30 to the outside of the free roller 22) is smaller than a sum of the diameter of the reversing roller 21 and the radius of the inner reel section 23. When the radius of the outer reel section (accurately, the distance from the center of the rotor 30 to the outside of the free roller 22) is greater than a sum of the diameter of the reversing roller 21 and the radius of the inner reel section 23, the size as a whole is almost the same as that when the inner reel section 23 and the rotor 30 are coaxially provided.

Next, rotary drive means of the rotor will be described. As this rotary drive means, means that is the same as that of a common cord reel can be appropriately selected and used. Specifically, a spring such as a spiral spring, a manual handle, a motor, and the like can be exemplified. As a mechanism using a spiral spring, one where the spiral spring is wound up when drawing out a cord and temporarily stopped in a state charged with a force, and this force is released to reel the cord can be exemplified, but this may be vice versa. As a structure for temporarily stopping the spiral spring, one with a ratchet mechanism (specifically, peripheral ratchet teeth of the rotor 30 are formed so as to prevent the rotor 30 from reversing by an engaging element that approaches and separates from the ratchet teeth, and the engaging element is released from the ratchet teeth manually such as by a button operation to thereby rotate the rotor 30 by a spiral spring force), and one with a stopping mechanism by a groove and a stop lever can be exemplified. In the following, description will be given of a turning structure by a spiral spring with a stopping mechanism by a groove and a stop lever.

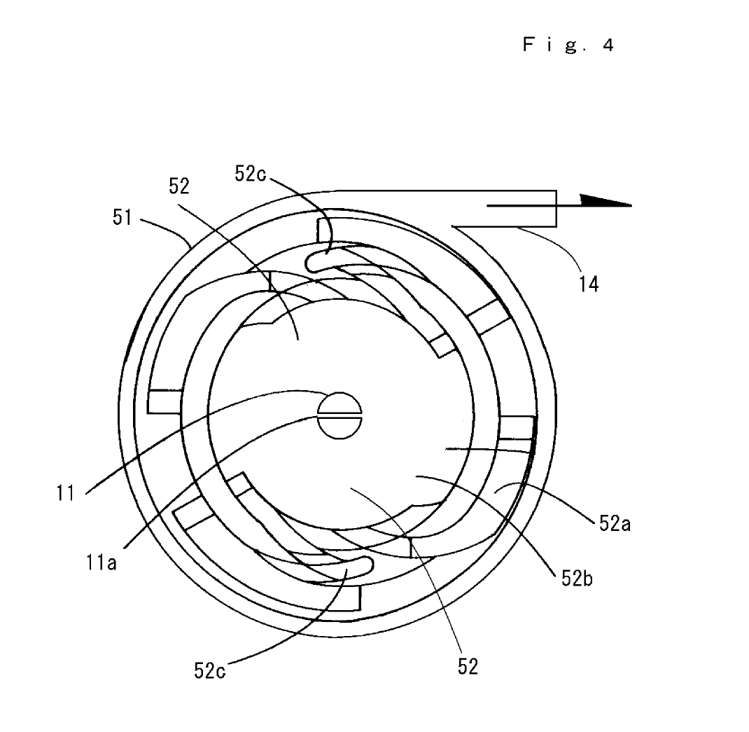

To a lower surface side of the rotor 30, as shown in FIG. 2 and FIG. 3, a spiral spring 38 disposed radially inside and a stop lever 37 disposed radially outside are fitted. The spiral spring 38 is locked at an outer peripheral end thereof to the rotor 30, and locked at an inner peripheral end thereof to a spiral spring locking groove 11a provided in the support shaft 11 (see FIG. 4). Accordingly, as a result of drawing out of the cord 12, the spiral spring 38 is wound up with clockwise pivoting of the rotor 30 to urge the rotor 30. When drawing out of the cord 12 is stopped to bring the cord 12 into a free state, the rotor 30 is rotated clockwise by the spiral spring 38 to reel the cord 12.

The stop lever 37 is pivotally attached at a base end side thereof to the rotor 30, provided at a front end lower surface thereof with a sliding piece 37a, and structured so that the sliding piece 37a slides with pivoting of the rotor 30 sequentially in a drawing-out groove 52a at the radially inside, a drawing-back groove 52b at the radially outside, and locking grooves 52c, 52c formed therebetween shown in FIG. 4 provided in an upper surface of a bottom wall 52 of the casing 51.

Next, operation of the cord reel will be briefly described. First, the cord 12 is pulled and drawn out of the casing 51. Accordingly, the stop lever 37 of the rotor 30 slides in the drawing-out groove 52a of the bottom wall 52 and the rotor 30 pivots clockwise, and the cord 12 is unreeled from the rotor 30 with this pivoting, so that the cord 12 can be drawn out of the casing 51. In addition, when the rotor 30 pivots clockwise with this drawing out of the cord 12, the spiral spring 38 is wound up to urge the rotor 30 counterclockwise. Then, when drawing out of the cord 12 is stopped, the rotor 30 attempts to pivot counterclockwise by an urging force of the spiral spring 38, but the stop lever 37 enters the locking groove 52c from the drawing-out groove 52a to stop the rotor 30 from pivoting, and this state is maintained. On the other hand, when the cord 12 is slightly drawn out in this stopped state, the stop lever 37 exits from the locking groove 52c and enters the drawing-back groove 52b. In this state, when the cord 12 that is being pulled is then released, the rotor 30 begins to pivot counterclockwise by an urging force of the spiral spring 38, the stop lever 37 slides in the drawing-back groove 52b at the pivoting and the rotor 30 continues pivoting to reel the cord 12. Thus, the cord 12 having been drawn out of the casing 51 can be drawn back into the casing 51.

In the examples shown in FIG. 1 to FIG. 3, the inner reel wheel 26, the intermediate wheel 27, and the rotor wheel 28 are provided at the same height, that is, the same position in terms of the direction along the axis of the rotor. Alternatively, the invention can also be carried out by having the axial (the direction along the axis) length of the intermediate wheel 27 longer than the axial length of the inner reel wheel 26 and the rotor wheel 28 and differentiating the position where the inner reel wheel 26 and the rotor wheel 28 mesh with the intermediate wheel 27 in terms of the axial direction, that is, vertically. Such a formation allows arranging the inner reel wheel 26 and the rotor wheel 28 in an overlapping manner in a plan view of the rotor, that is, as viewed in a direction along the axis of the rotor, so that the axis of the inner reel wheel 26 and the axis of the rotor wheel 28 can be approximated. Alternatively, it is also possible, not to provide the intermediate wheel 27 as a whole long in the axial direction as such, but to form only a shaft portion of the intermediate member long, provide the shaft portion with two first and second wheels at different axial positions, and arrange both the first and second wheels at mutually different axial positions so as to make one first wheel mesh with the rotor wheel 28 and make the second wheel mesh with the inner reel wheel 26.

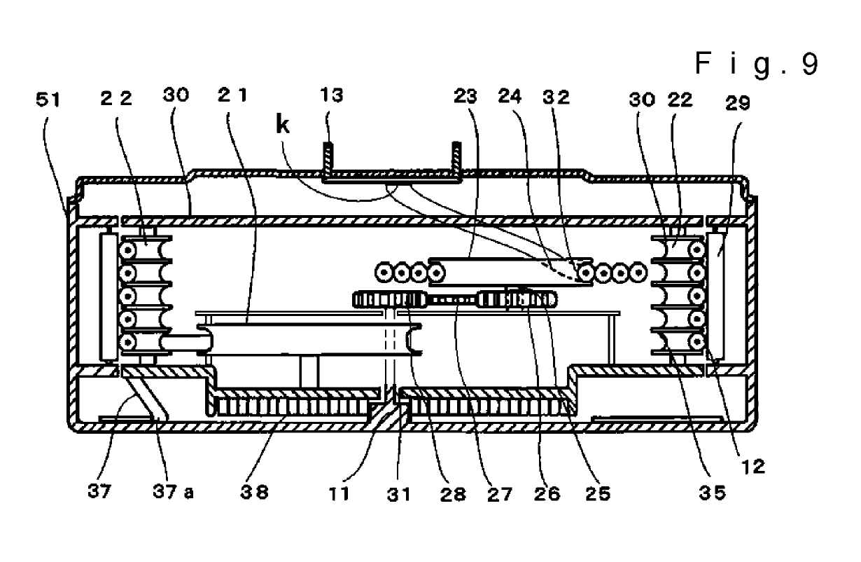

Another embodiment is shown in FIG. 9. The embodiment shown in FIG. 9 corresponds to claims 4 to 7.

In the examples shown in FIG. 1 to FIG. 3, respectively, the reversing roller 21 is provided at the same position as that of the inner reel roller 23 in terms of the direction along the axis of the rotor, that is, the vertical direction of FIG. 2 and FIG. 3.

In the embodiment shown in FIG. 9, as illustrated, the reversing roller 21 is provided at a position different from the inner reel roller 23 in terms of the direction along the axis of the rotor, that is, the vertical direction of FIG. 2 and FIG. 3.

Specifically, in the example shown in FIG. 9, the inner reel section 23 is arranged above the reversing roller 21. Also, in this example, the support shaft 11 is formed longer than that shown in FIG. 2, and the rotor wheel 28, the intermediate wheel 27, and the inner reel section wheel 26 are arranged above the reversing roller 21, but alternatively, the rotor wheel 28, the intermediate wheel 27, and the inner reel section wheel 26 can also be arranged at the same height as that of the reversing roller 21 or at a lower position (not shown).

As a result, the reversing roller 21 and the inner reel section 23 can be arranged in an overlapping manner in a plan view, that is, as viewed in the direction along the axis of the rotor, so that the axis of the reversing roller 21 and the axis of the inner reel section 23 can be further approximated.

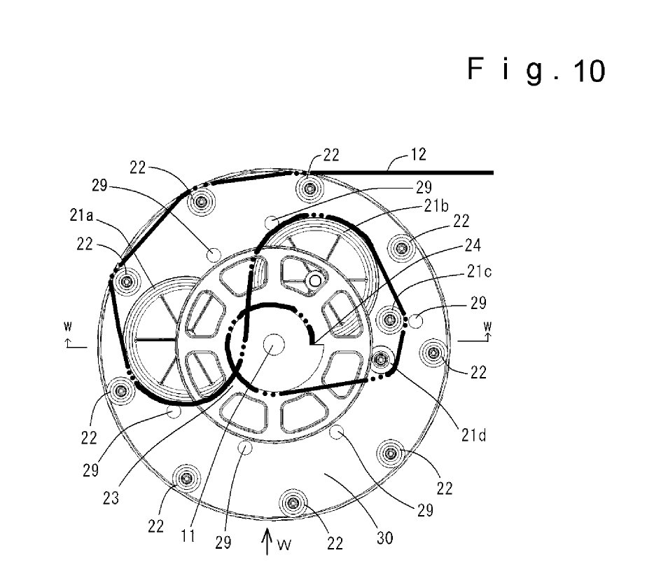

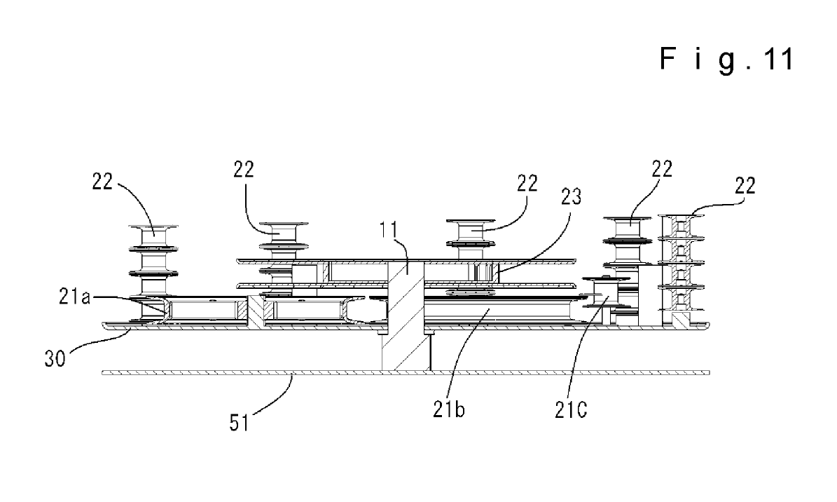

Next, an embodiment corresponding to claims 1 to 3 is shown in FIG. 10 and FIG. 11.

In this embodiment shown in FIG. 10 and FIG. 11, besides a reversing roller 21a, forward rollers 21b, 21c, 21d are separately provided in the rotor 30 as a guide section. That is, in this embodiment, the guide section is composed of the reversing roller 21a being a reversing section and the first forward roller 21b, the second forward roller 21c, and the third forward roller 21d being a forward-rotating section.

As shown in FIG. 10, a cord 12 that heads for an inner reel section 23 from free rollers 20 . . . 20 composing an outer reel section is laid on the reversing roller 21a, the cord 12 that exits from the reversing roller 21a and heads for the inner reel section 23 is laid on the first forward roller 21b, the cord 12 that heads for the inner reel section 23 from the first forward roller 21b is laid on the second forward roller 21c, and further, the cord 12 that heads for the inner reel section 23 from the second forward roller 21c is laid on the third forward roller 21d. Then, the cord 12 that has exited from the third forward roller 21d is wound onto the inner reel section 23.

In this embodiment, as shown in FIG. 11, the guide section, that is, the reversing roller 21a and the first to third forward rollers 21b to 21d are provided at a position different from that of the inner reel section 23 in terms of the axial direction of a support shaft 11 of the rotor 30, that is, a direction along said axis, and in a plan view of the rotor 30, that is, projection onto an imaginary plane perpendicular to said axis, the inner reel section 23, as shown in FIG. 10, has an overlapping part with each of the reversing roller 21a and the first to third forward rollers 21b to 21d.

Then, a part of the cord 12 between the reversing roller 21 and the first forward roller 21b and a part of the same wound around the inner reel section 23 three-dimensionally intersect at different positions in the direction along the axis of the rotor.

Specifically, of the cord 12 drawn in the reel shown in FIG. 10, apart from a position to begin to contact the reversing roller 21 to a position to contact a forward roller on which the cord is lastly laid, that is, the third forward roller 21d, three-dimensionally intersects with a part wound around the inner reel section 23 as mentioned above. The rollers of the guide section are thus arranged. In this case, it suffices even with a reel where a cord that does not three-dimensionally intersect in the above-mentioned parts when the reel amount of the cord 12 onto the inner reel section 23 is small and the diameter of the reeled cord (winding diameter) is small, if this cord three-dimensionally intersects in the above-mentioned parts when reeling has proceeded and the reeled cord has reached a large winding diameter.

By arranging the reversing roller 21 and the inner reel section 23 in an overlapping manner in a plan view as described above, the reel can be further downsized.

Moreover, as shown in FIG. 11, by locating the forward roller 21c intermediately between the reversing roller and the inner reel roller in terms of the direction along the axis of the rotor (vertical direction in FIG. 11), even in a reel where the position of the reversing roller 21a and the inner reel section 23 is different in terms of the direction along the axis of the rotor 30, feeding of the cord 12 can be smoothly performed. The forward roller to be arranged intermediately as such is not limited to be single, and a plurality of forward rollers may be arranged.

As shown in FIG. 10, when a fixing portion side of the cord 12 to the reel shown by an alternate long and two short dashed line is provided as a base end side of the cord 12 and the cord 12 is tracked from the base end side toward its front end side, the reeling direction of the cord 12 on the inner reel section 23 is counterclockwise, the reeling directions of the cord 12 on the forward rollers 21d, 21c, 21b are counterclockwise, respectively, and after reversing by the reversing roller 21, the reeling direction of the cord on the outer reel section is clockwise.

When reeling the cord 12, as a result of the rotor 30 rotating and the cord being reeled onto the outer reel section and the rollers of the guide section orbiting around the inner reel section 23 with a rotation of the rotor 30, the cord 12 is reeled around the inner reel section 23. Specifically, if the rotor 30 rotates counterclockwise, the reversing roller 21 and the forward rollers 21b, 21c, 21d orbit around the inner reel section 23 counterclockwise, relative to the inner reel section 23, to reel the cord 12 counterclockwise around the inner reel section 23.

In this embodiment shown in FIG. 10 and FIG. 11, the inner reel section 23 is fixed to a casing, and thus, although not shown, and thus like one shown in FIG. 2, the problem of a twist between the fitting portion k and the fixing portion 24 has also been solved.

As illustrated, the second and third forward rollers 21c, 21d have diameters smaller than those of the reversing roller 21a and the first forward roller 21b. However, the present invention is not limited to such a setting, and can also be carried out by providing the second and third forward rollers 21c, 21d as rollers having the same diameters as those of the reversing roller 21a and the first forward roller 21b or rollers having larger diameters than those of the reversing roller 21a and the first forward roller 21b.

Moreover, the numbers of the reversing and forward rollers mentioned above composing the guide section are also not limited to one and three, respectively, as illustrated. It suffices that the number of reversing rollers is an odd number, and the invention can be carried out even with the number of forward rollers of two or four or more, regardless of being an odd or even number.

Further, in the embodiment shown in FIG. 10 and FIG. 11, the rollers of the guide section that are, as shown in FIG. 10, despite a slight shift for smooth guiding, arranged substantially at the same position in terms of the axial direction of the support shaft have been shown, however, the present invention is not limited to such an arrangement, and by arranging also the rollers of the guide section at different positions in the axial direction of the support shaft, further downsizing can also be performed.

Further, in the embodiment shown in FIG. 10 and FIG. 11, the reversing roller 21a and the first forward roller 21b are each formed of one roller. However, for example, the reversing roller 21a itself can also be composed of a plurality of small-diameter rollers (not shown), like the outer reel section composed of a plurality of free rollers 22 . . . 22. In this case, without limitation to ones arranged in a circle, the invention can also be carried out by arranging the above-mentioned small-diameter rollers so as to be located at the vertices of another polygon.

Moreover, the individual small-diameter rollers may, as mentioned above, be arranged in a circle or another polygonal shape, but are not necessarily arranged so as to compose the whole of a circle or polygon, and can be provided even as small-diameter rollers that are arranged only in a path to make contact with the cord 12 shown by an alternate long and two short dashed line in FIG. 10. Moreover, in this case, components of the reversing roller are not limited to the small-diameter rollers provided to be pivotable on the rotor, and the invention can also be carried out even with a contact portion with a small frictional resistance of the surface provided not to be rotatable. The first forward roller 21b and the inner reel section 23 can also be composed of a plurality of guide members, such as this small-diameter roller group. However, the inner reel section 23, which reels the cord 12, thus may not be rotatable because it is not necessary that the cord 12 slides, and may have a large frictional resistance.

Moreover, using such a small-diameter roller group or another plurality of contact portions to compose a roller being a component of the guide section, such as a reversing roller, or to compose the inner reel section 23 is not limited to the reel shown in FIG. 10 and FIG. 11, and this can be carried out also for the reels shown in FIG. 1 to FIG. 3 and FIG. 5.

However, in any embodiment, where it is not preferred for the cord 12 to be bent, such as when having a metal core, it is preferable, when using small-diameter roller groups or a plurality of non-turning contact portions to compose each roller of the guide section or the inner reel section 23, to arrange the small-diameter rollers or contact portions that the cord is guided, between the small-diameter rollers or between the contact portions, with such a gentle curvature that the cord 12 is not bent.

Although not illustrated, also in the embodiments of FIG. 10 and FIG. 11 having been described above, as the inner reel section 23, a section along the axial direction of which a cord is wound and layered can be adopted, like one shown in FIG. 3.

In the embodiments shown in FIG. 10 and FIG. 11, matters that are not mentioned particularly are the same as those in other embodiments that have already been described.

Moreover, in the embodiments shown in FIG. 1 to FIG. 11, the free rollers 22, the interval control rollers 29, the reversing roller, and the forward rollers are not limited to rollers that rotate following the cord 12, the invention can also be carried out even with rollers that acquire a rotating force from known drive means such as a motor and voluntarily rotate to feed the cord 12.

Further, although not illustrated, in the embodiment shown in FIG. 10 and FIG. 11 mentioned above, the guide section may be embodied as a section that includes only the reversing roller 21 without including the forward rollers 21b to 21d. In thit case, the free roller 22 can also be embodied, as shown in FIG. 3, FIG. 5, and FIG. 9, as a roller that reels a cord to be layered in its axial direction. Moreover, the inner reel section 23 can also be embodied as a roller that reels a cord to be layered in its axial direction.

Moreover, with regard to the embodiments shown in FIG. 10 and FIG. 11, when the guide section is composed only of a reversing roller as mentioned above, the center of the inner reel section 23 can be fixed to the casing 51, at a position off the center of the rotor 30. In this case, a groove to relieve the center axis of the inner reel section 23 that orbits around relative to the rotor 30 with a rotation of the rotor 30, is provided in advance in the rotor 30, in order not to inhibit the rotor 30 from turning with respect to the casing 51. This groove is formed in an annular shape so as to be coincident with a locus of the center axis of the inner reel section 23 with respect to the rotor 30. Alternatively, in place of such a groove, the insertion hole 31 of the rotor 30 may be formed so as to have a diameter of a sufficient size not to inhibit the center axis of the inner reel section 23 from orbiting around.

Further, in either case where the inner reel section 23 is arranged on the axis of the rotor 30 or where, as mentioned above, the center axis of the inner reel section 23 is arranged at a position off the center axis of the rotor 30, the inner reel section 23 can also be provided at a side of the casing 51 opposite to the side where the rotor 30 is disposed. That is, if the rotor 30 is disposed at a bottom surface side (lower surface) of the casing 51, the inner reel section 23 can be provided at a top surface side (upper surface) of the casing 51.

Moreover, in the embodiments shown in FIG. 10 and FIG. 11, when the center axis of the inner reel section 23 is arranged at a position off the center axis of the rotor 30, the reversing roller may not be overlapped with the inner reel section 23 in a plan view, that is, projection onto an imaginary plane perpendicular to the axial direction of the rotor.

As described above, the present invention can be modified in various ways according to the description of the claims, and, for example, the cord 12 serving as a to-be-wound object can be modified to various elongated bodies, such as hoses that run fluids such as water and air other than electricity, threads, strings, metal wires, etc., besides power cords and communications cords.

1. A reel for winding an elongated body, the reel including a rotor that pivots relative to a base, an outer reel section provided at an outer peripheral side of the rotor, an inner reel section formed at an inner peripheral side of the rotor and inside of the outer reel section, and a guide section, an elongated body being wound in one direction on the outer periphery of the inner reel section, and the guide section guiding the elongated body extending from the inner reel section to the outer reel section, wherein
the inner reel section is fixed to the base, the rotor is provided to be pivotable relative to the inner reel section, and the guide section orbits around the inner reel section with the pivoting of the rotor, and
the guide section is disposed at a position different from that of the inner reel section in terms of a direction along the axis of the rotor.

2. The reel for winding an elongated body according to claim 1, wherein
the guide section is a reversing roller that reverses the elongated body extending from the inner reel section to be wound on the outer periphery of the outer reel section and pulled out to the outer periphery of the rotor,
a center axis of the inner reel section is disposed so as to be coincident with a center axis of pivoting of the rotor, and
in projection onto a plane perpendicular to the axis of the rotor, at least a part of the inner reel section overlaps with the guide section.

3. The reel for winding an elongated body according to claim 1, wherein
the guide section includes a forward-rotating section and a reversing section,
the forward-rotating section being for guiding without reversing the elongated body extending from the reel section to the reversing section,
the reversing section being for reversing the elongated body extending from the forward-rotating section to be wound on the outer periphery of the outer reel section and pulled out to the outer periphery of the rotor, and
a part of the elongated body between the forward-rotating section and the reversing section three-dimensionally intersects with a part of the elongated body wound around the inner reel section at different positions in terms of the direction along the axis of the rotor.

4. A reel for winding an elongated body, the reel including a rotor that pivots relative to a base, an outer reel section provided at an outer peripheral side of the rotor, and an inner reel section formed at an inner peripheral side of the rotor and inside of the outer reel section, an elongated body being wound in one direction on the outer periphery of the inner reel section, and the elongated body extending from the inner reel section on the outer periphery of the outer reel section being pulled out to the outer periphery of the rotor, wherein
the inner reel section is provided to be pivotable relative to the rotor, and a pivot shaft of the inner reel section is disposed at a position different from that of a center axis of pivoting of the rotor, and
an inner reel section pivoting device that pivots the inner reel section relative to the rotor is included.

5. The reel for winding an elongated body according to claim 4, wherein
the elongated body extending from the inner reel section is reversed to be wound around the outer reel section, and pulled out to the outer periphery of the rotor, and
the inner reel section pivoting device pivots the inner reel section in an opposite direction to a direction of pivoting of the rotor.

6. The reel for winding an elongated body according to claim 4, wherein
a reversing roller that reverses the elongated body is provided between the outer reel section and the inner reel section to be pivotable relative to the rotor, and
the outer reel section has a radius smaller than a sum of a diameter of the reversing roller and a radius of the inner reel section.

7. The reel for winding an elongated body according to claim 4, wherein
for the outer reel section, a plurality of free rollers and a reversing roller are arranged spaced apart from each other in an annular shape,
an elongated body wound around the inner reel section is reversed at the outer periphery of the reversing roller, and
the elongated body, which is a power or communications cord including a metal wire inside, includes a spiral spring that urges the rotor in one rotating direction, and rotates the rotor by an elasticity of the spiral spring to thereby wind the cord.

8. The reel for winding an elongated body according to claim 4, wherein
a plurality of turns of a cord is wound around the inner reel section so as to be layered in a radial direction of the inner reel section, and a plurality of turns of the cord is wound around the outer reel section so as to be layered in an axial direction of the outer reel section.

9. The reel for winding an elongated body according to claim 4, wherein
a reversing section that reverses the elongated body extending from the inner reel section to be wound on the outer periphery of the outer reel section and pulled out to the outer periphery of the rotor is included, and
a part of the elongated body between the reversing section and the inner reel section three-dimensionally intersects with a part of the elongated body wound around the inner reel section at different positions in terms of a direction along the axis of the rotor.

10. The reel for winding an elongated body according to claim 5, wherein
a reversing roller that reverses the elongated body is provided between the outer reel section and the inner reel section to be pivotable relative to the rotor, and
the outer reel section has a radius smaller than a sum of a diameter of the reversing roller and a radius of the inner reel section.

11. The reel for winding an elongated body according to claim 5, wherein
for the outer reel section, a plurality of free rollers and a reversing roller are arranged spaced apart from each other in an annular shape,
an elongated body wound around the inner reel section is reversed at the outer periphery of the reversing roller, and
the elongated body, which is a power or communications cord including a metal wire inside, includes a spiral spring that urges the rotor in one rotating direction, and rotates the rotor by an elasticity of the spiral spring to thereby wind the cord.

12. The reel for winding an elongated body according to claim 6, wherein
for the outer reel section, a plurality of free rollers and a reversing roller are arranged spaced apart from each other in an annular shape,
an elongated body wound around the inner reel section is reversed at the outer periphery of the reversing roller, and
the elongated body, which is a power or communications cord including a metal wire inside, includes a spiral spring that urges the rotor in one rotating direction, and rotates the rotor by an elasticity of the spiral spring to thereby wind the cord.

13. The reel for winding an elongated body according to claim 5, wherein
a plurality of turns of a cord is wound around the inner reel section so as to be layered in a radial direction of the inner reel section, and a plurality of turns of the cord is wound around the outer reel section so as to be layered in an axial direction of the outer reel section.

14. The reel for winding an elongated body according to claim 6, wherein
a plurality of turns of a cord is wound around the inner reel section so as to be layered in a radial direction of the inner reel section, and a plurality of turns of the cord is wound around the outer reel section so as to be layered in an axial direction of the outer reel section.

15. The reel for winding an elongated body according to claim 7, wherein
a plurality of turns of a cord is wound around the inner reel section so as to be layered in a radial direction of the inner reel section, and a plurality of turns of the cord is wound around the outer reel section so as to be layered in an axial direction of the outer reel section.
